(19) United States
(12) Patent Application Publication
(10) Pub. No.: US 2011/0253319 A1
(43) Pub. Date: Oct. 20, 2011

(54) BLIND OR SHADE

(76) Inventor: John F. Schaupp, Sylvania, OH (US)

(21) Appl. No.: 13/088,056

(22) Filed: Apr. 15, 2011

Related U.S. Application Data
(60) Provisional application No. 61/324,804, filed on Apr. 16, 2010.

(51) Int. Cl. E06B 9/38; G05B 23/02; H02M 7/02; E06B 9/24; F21V 33/00

(52) U.S. Cl. 160/127; 362/253; 363/13; 340/3.1

(57) ABSTRACT

A shade or blind comprises a header and a photovoltaically active area. The photovoltaically active area is suspended from the header. The shade or blind further comprises a light and conductors coupling the photovoltaically active area to the light.

This application claims the benefit of the Apr. 16, 2010 filing date of U.S. Ser. No. 61/324,804 under 35 U. S. C. §119(e). The disclosure of U.S. Ser. No. 61/324,804 is hereby incorporated herein by reference.

This invention relates to energy-saving devices. It is disclosed in the context of a combination of a blind or shade and a lighting device.

According to an aspect of the invention, a shade or blind comprises a header, a photovoltaically active area, the photovoltaically active area being suspended from the header, a light, and conductors coupling the photovoltaically active area to the light.

Illustratively according to this aspect, the apparatus further comprises a switch coupled between the photovoltaically active area and the light.

Illustratively according to this aspect, the apparatus further comprises a rechargeable battery coupled to the photovoltaically active area to be recharged from the photovoltaically active area.

Illustratively according to this aspect, the apparatus further comprises a voltage regulator coupled to the photovoltaically active area and to the rechargeable battery to regulate the voltage.

Illustratively according to this aspect, the photovoltaically active area is provided on a slat of a blind, the slat having two opposite sides, the photovoltaically active area being provided on one of the sides.

Illustratively according to this aspect, the blind comprises multiple slats, each slat having two opposite sides.

Illustratively according to this aspect, the apparatus comprises multiple lights, at least one of the multiple lights being provided on each of a plurality of the multiple slats.

Illustratively according to this aspect, the multiple lights produce various colors of light, the multiple lights being arranged and controlled to produce patterns on the slats.

Illustratively according to this aspect, the photovoltaically active area comprises a flexible photovoltaic film provided on a shade.

Illustratively according to this aspect, the light comprises at least one of a liquid crystal display, a light emitting diode, a plasma display, and a thin panel light.

Illustratively according to this aspect, the apparatus further includes a source for providing at least one of modulated and AC power to the light.

Illustratively according to this aspect, the apparatus further comprises a photosensor to turn on the light after the ambient light level becomes low enough.

Illustratively according to this aspect, the apparatus further comprises a timer coupled in circuit with the photosensor to turn the light off after a period of time has passed after the light has been turned on.

Illustratively according to this aspect, the apparatus further comprises a motion sensor coupled in circuit with the photosensor to turn on the light after the ambient light level becomes low enough only when motion is first detected after the ambient light level becomes low enough to turn on the light.

Illustratively according to this aspect, the apparatus further comprises an actuator for controlling the orientation of the photovoltaically active area.

Illustratively according to this aspect, the apparatus further comprises an electrical grid, an inverter, the output of which is synchronized in phase to the electrical grid, and conductors coupling an output of the inverter to the electrical grid, the outputs of the photovoltaic cell being coupled to the inverter, the alternating current produced at the output of the inverter being coupled to the grid.

According to an aspect of the invention, a blind includes a header, a switch, a photosensor for controlling the switch, a rechargeable battery, a voltage regulator, and multiple slats. Each slat has two sides. The blind further includes an actuator for controlling the orientations of the slats. The slats are suspended from the header by the actuator. One side of at least one of the slats includes at least one photovoltaic cell, and one side of at least one of the slats includes a light. Electrical conductors couple the at least one photovoltaic cell to the voltage regulator, the voltage regulator to the rechargeable battery, and the rechargeable battery through the switch to the light.

Illustratively according to this aspect, the switch, photosensor, rechargeable battery and voltage regulator are provided in the header.

Illustratively according to this aspect, one side of each of a plurality of the slats includes a photovoltaic cell, and the other side of each of the same plurality of the slats includes a light.

According to an aspect of the invention, a blind includes a header, a switch, a photosensor for controlling the switch, a rechargeable battery, a voltage regulator, and multiple slats. Each slat has two sides. The blind further includes an actuator for controlling the orientations of the slats. The slats are suspended from the header by the actuator. One side of at least one of the slats includes at least one photovoltaic cell. One side of at least one of the slats includes a light. The rechargeable battery is mounted in at least one of the slats. Electrical conductors couple the at least one photovoltaic cell to the voltage regulator, the voltage regulator to the rechargeable battery, and the rechargeable battery through the switch to the light.

Illustratively according to this aspect, the switch, photosensor and voltage regulator are provided in the header.

Illustratively according to this aspect, each of a plurality of the slats includes a rechargeable battery, one side of each of said plurality of the slats includes a photovoltaic cell, and the other side of each of said plurality of the slats includes a light.

Illustratively according to this aspect, each of a plurality of the slats includes a rechargeable battery and a voltage regulator, one side of each of said plurality of the slats includes a photovoltaic cell, and the other side of each of said plurality of the slats includes a light.

Illustratively according to both aspects, the lights produce various colors of light, and the lights are controlled to produce patterns on the slats.

Illustratively according to both aspects, the light comprises at least one of a liquid crystal display, a light emitting diode, a plasma display, and a thin panel light.

Illustratively according to both aspects, the apparatus further includes a source for providing at least one of modulated and AC power to the light.

Illustratively according to both aspects, the apparatus further includes a motion sensor coupled in circuit with the photosensor to turn on the light after the ambient light level becomes low enough only when motion is first detected after the ambient light level becomes low enough to turn on the light.

Illustratively according to both aspects, the apparatus further includes a timer coupled in circuit with the photosensor to turn the light off after a period of time has passed after the light has been turned on, but no motion has been detected.

Illustratively according to both aspects, the apparatus further includes an electrical grid, an inverter, the output of which is synchronized in phase to the electrical grid, and conductors coupling an output of the inverter to the electrical grid. The outputs of the photovoltaic cell are coupled to the inverter. The alternating current produced at the output of the inverter is coupled to the grid.

The invention may best be understood by referring to the following detailed description and accompanying drawings which illustrate the invention. In the drawings:

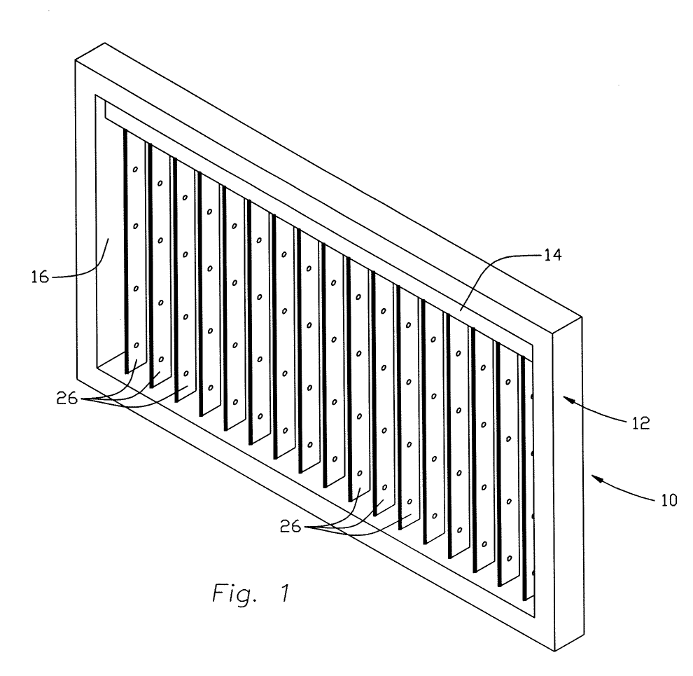

FIG. 1 illustrates a perspective view of a window incorporating a blind constructed according to the invention;

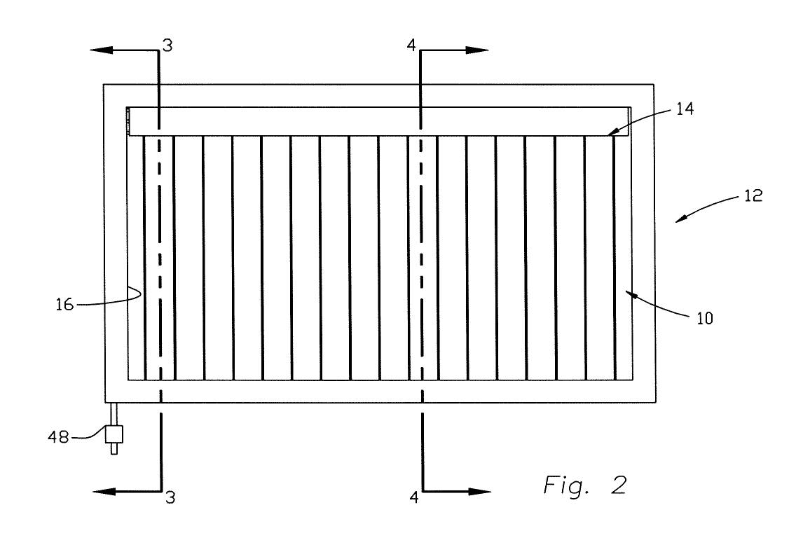

FIG. 2 illustrates an elevational view of the blind illustrated in FIG. 1;

FIG. 3 illustrates a sectional view of the blind illustrated in FIGS. 1-2 taken generally along section lines 3-3 of FIG. 2;

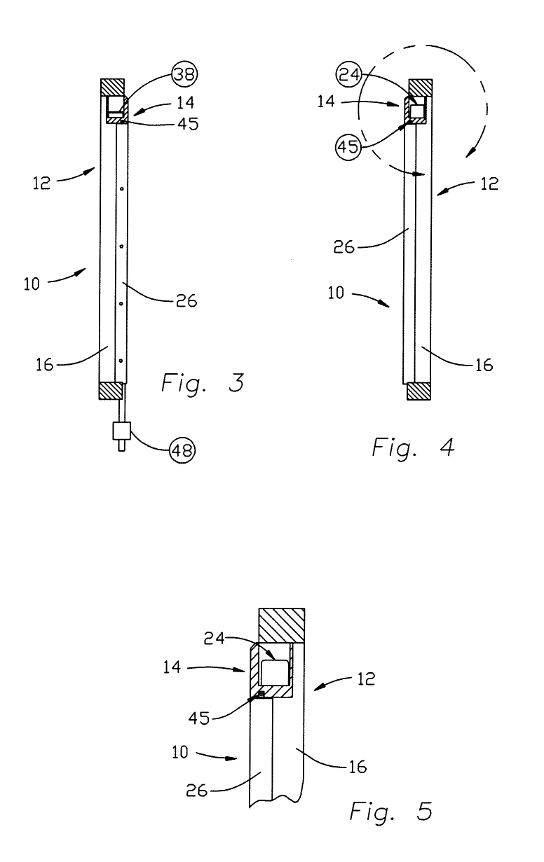

FIG. 4 illustrates a sectional view of the blind illustrated in FIGS. 1-3 taken generally along section lines 4-4 of FIG. 2;

FIG. 5 illustrates an enlarged fragmentary sectional view showing certain details of FIG. 4;

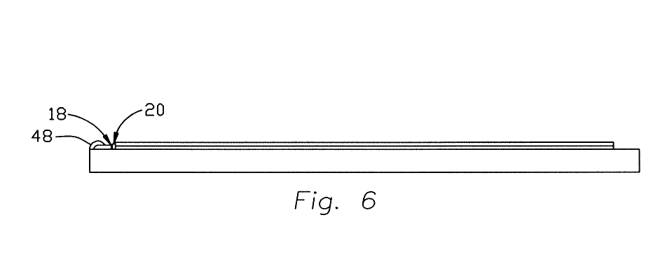

FIG. 6 illustrates a top plan view of the blind illustrated in FIGS. 1-5;

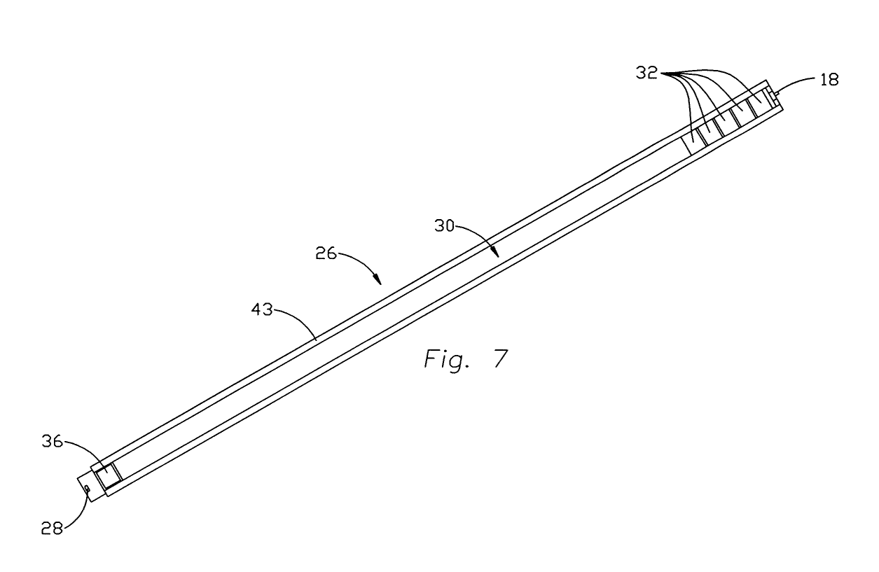

FIG. 7 illustrates a sun-side elevational view of a single slat of a blind constructed according to the invention;

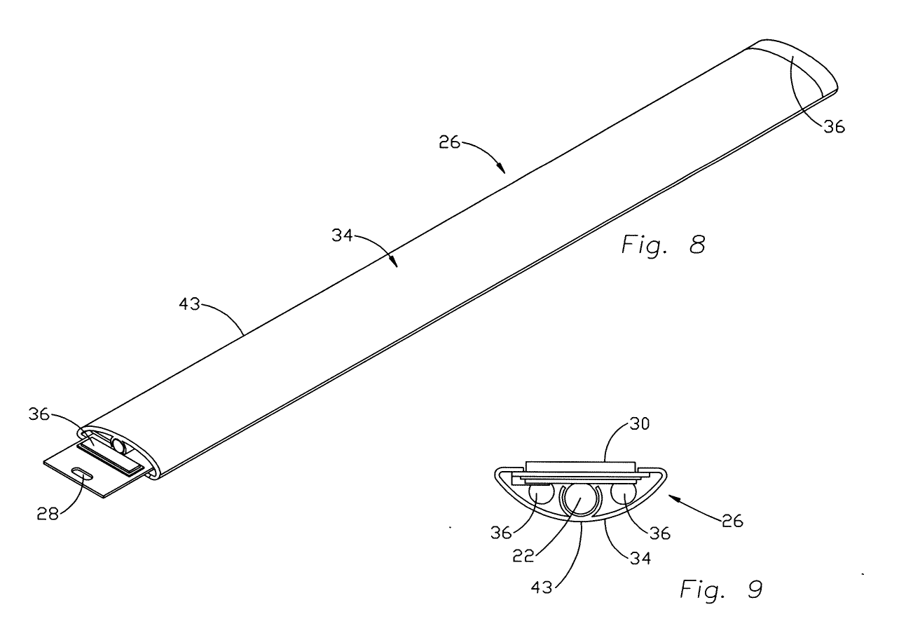

FIG. 8 illustrates a perspective view of the room side of the slat illustrated in FIG. 8;

FIG. 9 illustrates an end view of the slat illustrated in FIGS. 8-9;

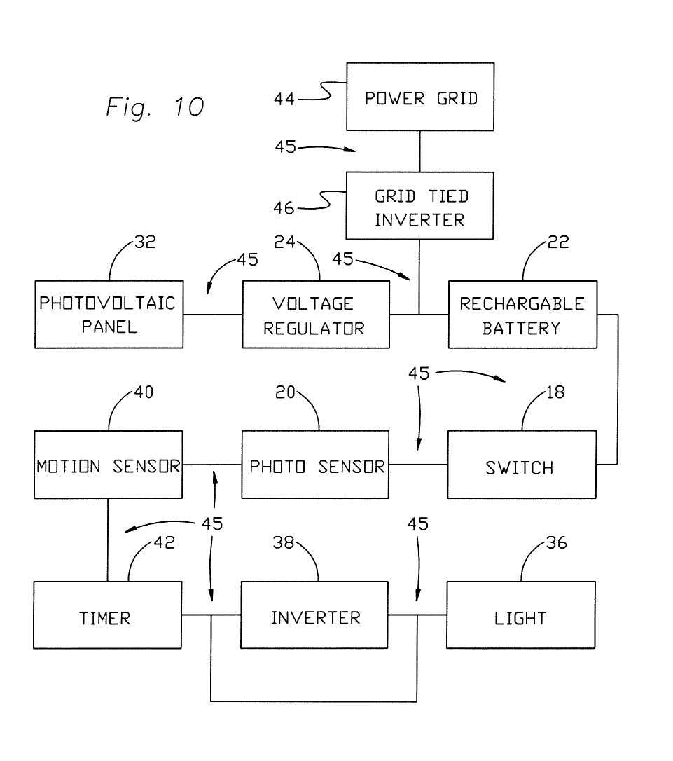

FIG. 10 illustrates a typical circuit including a blind of the type contemplated by FIGS. 1-9, showing various options which may be useful in the circuit;

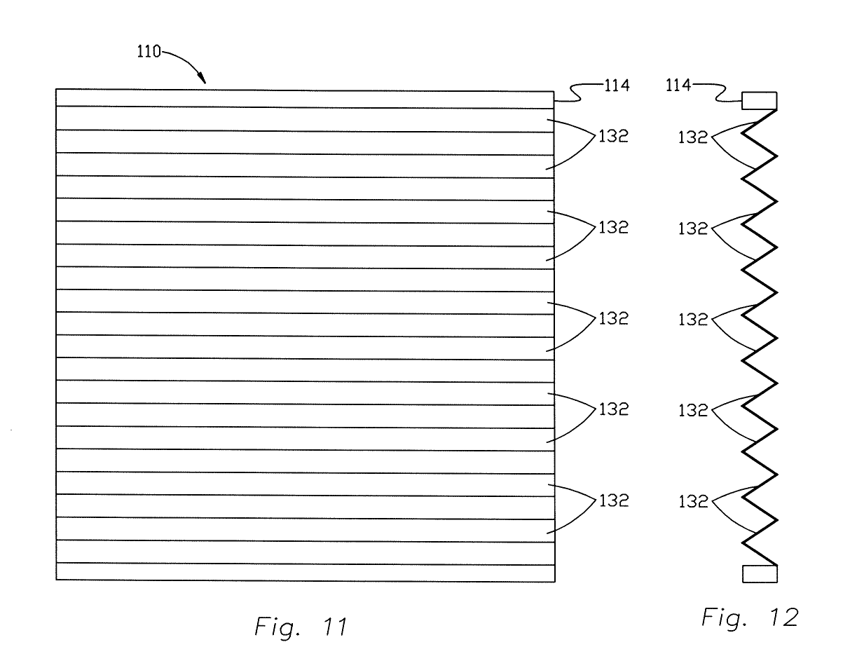

FIG. 11 illustrates a sun-side elevational view of an accordion pleated-type shade constructed according to the invention;

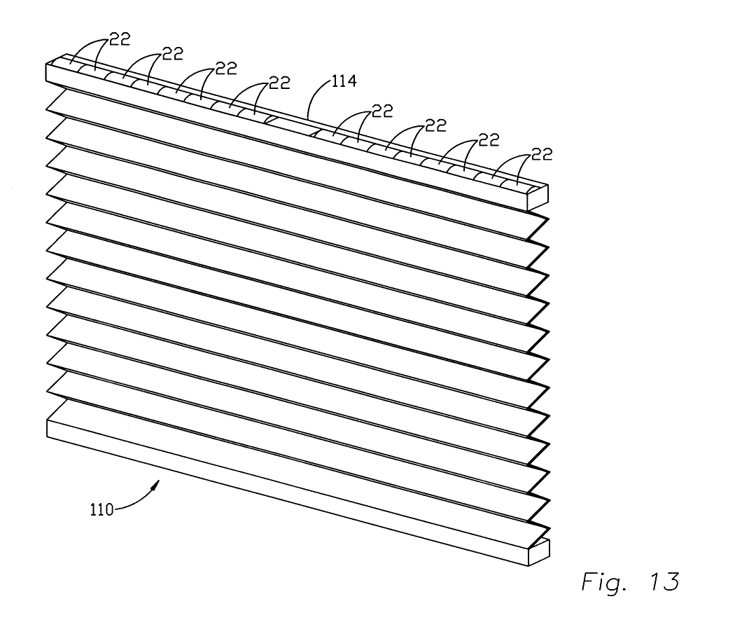

FIG. 12 illustrates an end elevational view of the shade illustrated in FIG. 11; and,

FIG. 13 illustrates a room-side perspective view of the shade illustrated in FIGS. 11-12.

In the descriptions that follow, schematic (a) and/or block diagram(s) will be described. Specific components, sources, and in some cases, names and numbers of those components will be provided. However, it is to be understood that other components capable of performing equivalent functions to those specifically identified components may be available from the same, or different, sources. Thus, this invention is not limited to the specifically identified components or the specifically identified sources.

A blind 10 (FIGS. 1-6) comes in various sizes to accommodate various standard and non-standard sizes of door (for example, a sliding glass or other transparent material door) or window openings 12. The blind 10 includes a header 14 which is sized to mount adjacent the window opening 12, for example, on the frame or trim 16 surrounding the window opening 12. Header 14 supports the remaining blind 10 structure. (An) on/off switch(es) 18 (FIGS. 6, 7 and 10), (a) photosensor(s) 20 (FIGS. 6 and 10), (a) rechargeable battery(ies) 22 (FIGS. 9 and 10) and (a) voltage regulator(s) 24 (FIGS. 4, 5 and 10) may be provided in the header 14, and/or elsewhere on the blind 10. An illustrative switch 18 is the Radio Shack 275-011 SPST pushbutton switch. An illustrative photosensor 20 is the Radio Shack 276-1657 CdS photoresistor. An illustrative battery 22 is a PowerGenix NiZn rechargeable battery. An illustrative voltage regulator 24 is the LM317T linear regulator.

The multiple slats 26 (FIGS. 1-5 and 7-9) of the blind 10 are suspended from the header 14 in known configuration (which typically may be either vertical or horizontal, although vertical is illustrated) by suitable means 28 (FIGS. 7 and 8), such as cords, strings or the like strung through openings in the slats 26. The blind 10 can, for example, be sold and/or installed one slat 26 at a time. Means 28 may be as simple as a string or cord strung through openings 29 provided adjacent what will be the upper ends of slats 26 and suspended in the header 14. In this way, the slats 26 can even be adjusted independently of one another to suit the needs of a user. One side 30 (FIGS. 7 and 9) of at least one, preferably more than one, and up to all or almost all, of the slats 26 include(s) (a) photovoltaic cell(s) 32 (FIGS. 7 and 10). An illustrative photovoltaic cell 32 is the Powerfilm SP3-37 flexible solar panel. The other side 34 (FIGS. 8 and 9) of at least one, preferably more than one, and up to all or almost all, of the slats 26 include(s) (a) light(s) 36 (FIGS. 8, 9 and 10), such as (a) liquid crystal display (LCD), light emitting diode (LED), plasma display, or thin panel light. An illustrative light 36 is the Radio Shack 10 mm ultra high brightness red LED model 276-015. (A) light(s) 36 may also be provided on side(s) 30 of one or more of slats 36, as illustrated in FIG. 7.

The voltage regulator 24 is used in charging the battery(ies) 22 from the photovoltaic cell(s) 32. If a modulated or AC source is required to power the light(s) 36, a source 38 (FIGS. 3 and 10), such as an oscillator and appropriate additional circuitry, such as (an) amplifier(s), buffer(s) and the like, and/or an inverter, can be provided in the header 14, and/or elsewhere on the blind 10 to provide the modulated or AC power to the light(s) 36. An illustrative inverter 38 is the Belkin F5C412uk300W inverter.

The photosensor 20 provides a signal which can be conditioned to energize the light(s) 36. See FIG. 10. The conditioned signal from the photosensor 20 can automatically turn on the light(s) 36 when the outside light level becomes sufficiently low, such as in the evening. The photosensor 20 may also be replaced by, or may work in concert with, a motion sensor 40 of any of various types and/or a timer 42 of any of various types, which can be employed to turn the light(s) 36 on, for example, when motion is first detected after the light level becomes low enough to turn the light(s) 36 on and then to turn the light(s) 36 off, for example, after a period of time has passed after the light(s) 36 has (have) been turned on, but no motion has been detected in the room where the motion sensor 40 is located. An illustrative motion sensor 40 is the Chamberlain CWPIR motion-alert add-on sensor. An illustrative timer 42 is the Texas Instruments TLC555 timer.

In other embodiments, one or multiple rechargeable battery(ies) 22, one or multiple voltage regulator(s) 24, one or multiple switch(es) 18, one or multiple photosensor(s) 20, one or multiple motion sensor(s) 40, one or multiple timer(s) 42 and one or multiple inverter(s) 38 can be distributed as necessary and/or desirable among the various slats 26 of the blind 10, up to and including each slat 26 incorporating its own rechargeable battery(ies) 22 and/or voltage regulator 24 and/or switch 18 and/or photosensor 20 and/or motion sensor 40 and/or timer 42 and/or inverter 38.

At times of high availability, such as during sunny days, using the means 28, the user can manipulate the orientations of the slats 26 in an effort to optimize the shading effect of the blind 10 as well as the output(s) of the photovoltaic cell(s) 32. Sunlight impinging on the photovoltaic cell(s) 32 causes current to flow in the photovoltaic cell(s) 32 to charge the battery(ies) 22 under the control of the voltage regulator(s) 24. The fading of the natural light, for example, as the sun sets, is sensed by the photosensor 20. The photosensor 20 outputs a signal which is conditioned by, for example, (an) amplifier(s), and is used to switch the battery(ies) 22 into circuit with the light(s) 36, lighting the room. The light(s) 36 can be one(s) which produce(s) a white, or almost white, light or light of a particular one or more colors. The white and various colors can be controlled to produce pictures, letters and symbols, such as, for example, college logos or the like. A protective lens 43, for example, a slide-on or snap-on lens (FIGS. 7-9) can be provided on each slat 26 to cover and protect the components housed behind the lens 43. In illustrated embodiments, light(s) 36 shine(s) through the lens 43. The lens 43 may be colored, for example, to enhance this effect. Additionally, the light 36 can be indirect, in the nature of a glowing panel, or the light 36 can illuminate in the direction of the floor or into the header 14 to provide more indirect lighting.

Electrical conductors 45 (FIG. 10) for completing the circuits among the various photovoltaic cell(s) 32, rechargeable battery(ies) 22, voltage regulator(s) 24, switch(es) 18, photosensor(s) 20, motion sensor(s) 40, timer(s) 42, inverter(s) 38, light(s) 36, and any other components distributed among the slats 26 and header 14 can be run up and down the blind 10 along with any cords, strings or the like of the means 28, and may, in appropriate circumstances, be integrated into such cords, strings or the like. The light(s) 36 or (an) additional light(s) 36 can be housed in the header 14.

In other embodiments, a rollup-type or accordion pleated-type shade 110 (see FIGS. 11-13) is used instead of a slat-type blind 10. The rollup or accordion pleated shade 110 incorporates strips of flexible photovoltaic film 132 on its side facing outward (herein sometimes sun-side) to be exposed to the sun when the shade 110 is deployed. In these embodiments, the light(s) may be disposed on the header 114 by which the shade 110 is suspended adjacent the window or door.

In other embodiments, the photovoltaic cell(s) 32 produce(s) enough output not only to recharge battery(ies) 22, but also for other devices, or to supply an electrical grid 44. In such cases, the output(s) of the photovoltaic cell(s) 32 is (are) coupled to (an) inverter(s) 46, such as (a) grid-tie single panel 32 inverter(s) or the like, the output(s) of which is (are) synchronized to the phase of the power on the grid 44. An illustrative grid-tie inverter 46 is the Xantrex model 864-1001 grid tie inverter. The alternating current thus produced is supplied through (a) suitable conductor(s) 48 to the grid.

What is claimed is:

1. A shade or blind comprising a header, a photovoltaically active area, the photovoltaically active area being suspended from the header, a light, and conductors coupling the photovoltaically active area to the light.

2. The apparatus of claim 1 further comprising a switch coupled between the photovoltaically active area and the light.

3. The apparatus of claim 1 further comprising a rechargeable battery coupled to the photovoltaically active area.

4. The apparatus of claim 3 further comprising a voltage regulator coupled to the photovoltaically active area and to the rechargeable battery.

5. The apparatus of claim 1 wherein the photovoltaically active area is provided on a slat of a blind, the slat having two opposite sides, the photovoltaically active area being provided on one of the sides.

6. The apparatus of claim 5 wherein the blind comprises multiple slats, each slat having two opposite sides.

7. The apparatus of claim 6 comprising multiple lights, at least one of the multiple lights being provided on each of a plurality of the multiple slats.

8. The apparatus of claim 7 wherein the multiple lights produce various colors of light, the multiple lights being arranged and controlled to produce patterns on the slats.

9. The apparatus of claim 1 wherein the photovoltaically active area comprises a flexible photovoltaic film provided on a shade.

10. The apparatus of claim 1 wherein the light comprises at least one of a liquid crystal display, a light emitting diode, a plasma display, and a thin panel light.

11. The apparatus of claim 1 further including a source for providing at least one of modulated and AC power to the light.

12. The apparatus of claim 1 further comprising a photosensor to turn on the light after the ambient light level becomes low enough.

13. The apparatus of claim 12 further comprising a timer coupled in circuit with the photosensor to turn the light off after a period of time has passed after the light has been turned on.

14. The apparatus of claim 12 further comprising a motion sensor coupled in circuit with the photosensor to turn on the light after the ambient light level becomes low enough only when motion is first detected after the ambient light level becomes low enough to turn on the light.

15. The apparatus of claim 1 further comprising an actuator for controlling the orientation of the photovoltaically active area.

16. The apparatus of claim 1 further comprising an electrical grid, an inverter, the output of which is synchronized in phase to the electrical grid, and conductors coupling an output of the inverter to the electrical grid, the outputs of the photovoltaic cell being coupled to the inverter, the alternating current produced at the output of the inverter being coupled to the grid.

17. The apparatus of claim 1 further comprising a direct current port coupled to the photovoltaically active area to provide a source of direct current voltage.
